(19) United States
(12) Patent Application Publication
(10) Pub. No.: US 2007/0195224 A1
(43) Pub. Date: Aug. 23, 2007

(54) OPTICAL SHEET AND BACKLIGHT MODULE USING THE SAME

(75) Inventor: SHAO-HAN CHANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,623

(22) Filed: Sep. 1, 2006

(30) Foreign Application Priority Data
Feb. 17, 2006 (CN) 200610033837.1

(51) Int. Cl. G02F 1/1335

(52) U.S. Cl. 349/65

(57) ABSTRACT

An optical sheet (21) includes a main body (210). The main body has a light incident surface (211) and a light emitting surface (212) positioned opposite to the light incident surface. A number of first and second elongated V-shaped grooves are defined on the light emitting surface. The first elongated V-shaped grooves are aligned apart and extend along a first direction, and the second elongated V-shaped grooves are aligned apart and extend along a second direction. The first direction intersecting with the second direction, whereby a plurality of frustum protrusions (213) are formed on the emitting surface in a matrix manner.

### FIELD OF THE INVENTION

The present invention generally relates to optical sheets and backlight modules using the same.

### DISCUSSION OF THE RELATED ART

Most liquid crystal display (LCD) devices are passive devices in which images are displayed by controlling an amount of light inputted from an external light source. Thus, a separate light source (for example, backlight module) is generally employed to illuminate an LCD panel of the LCD device.

Referring to FIG. 1, a typical backlight module 10 is shown. The backlight module 10 includes a prism sheet 11, a first diffusion sheet 12, a second diffusion sheet 13, and a light source 15. The prism sheet 11 includes a light incident surface 111, and a light emitting surface 112 located at the opposite side of the light incident surface 111. A plurality of elongated V-shaped grooves (not labeled) are defined in the light emitting surface 112 regularly in a direction and parallel to each other. The prism sheet 11 is located between the first diffusion sheet 12 and the second diffusion sheet 13, with the light emitting surface 112 adjacent to the first diffusion sheet 12, and the light incident surface 111 adjacent to the second diffusion sheet 13. The light source 15 is located adjacent to the second diffusion sheet 13. When light rays from the light source 15 are emitted into the prism sheet 11 after being scattered in the second diffusion sheet 13, the light rays are refracted in the prism sheet 11 and then emit into the first diffusion sheet 12. The light rays are scattered from the first diffusion sheet 12 and finally emitted into an LCD panel (not shown) disposed on the first diffusion sheet 12.

In order to improve optical uniformity, a diffusion plate 14 is provided. The diffusion plate 14 is located between the second diffusion sheet 13 and the light source 15. Referring to FIG. 2, the diffusion plate 14 includes a transparent main body 141 and a plurality of dispersion particles 142 dispersed in the main body 141. The dispersion particles 142 are configured for dispersing the light rays. When the light rays are emitted into the diffusion plate 14, the light rays are scattered by the dispersion particles 142 time after time, and improving optical uniformity.

However, the backlight module 10 is easy to cause Newton ring interference action because the V-shaped grooves extend out of the light emitting surface 112 regularly in a direction, thereby decreasing the optical uniformity.

Therefore, a new optical sheet and a backlight module using the same are desired in order to overcome the above-described shortcomings.

### SUMMARY

An optical sheet according to a preferred embodiment includes a main body. The main body has a light incident surface and a light emitting surface positioned opposite to the light incident surface. A number of first and second elongated V-shaped grooves are formed on the light emitting surface. The first elongated V-shaped grooves are aligned apart and extend along a first direction, and the second elongated V-shaped grooves are aligned apart and extend along a second direction. The first direction intersecting with the second direction, whereby a plurality of frustum protrusions are formed on the emitting surface in a matrix manner.

A backlight module according to another preferred embodiment includes a light source and an optical sheet having a light incident surface. The light source is positioned adjacent to the light incident surface of the optical sheet. The same optical sheet described in the previous paragraph is employed in this embodiment.

Other novel features will become more apparent from the following detailed description when taken in conjunction with the accompanying drawings.

### BRIEF DESCRIPTION OF THE DRAWINGS

Many aspects of the optical sheet and the backlight module using the same can be better understood with reference to the following drawings. The components in the drawings are not necessarily drawn to scale, the emphasis instead being placed upon clearly illustrating the principles of the present optical sheet and the backlight module using the same. Moreover, in the drawings, like reference numerals designate corresponding parts throughout the several views.

FIG. 1 is a schematic view of a conventional backlight module including a diffusion plate;

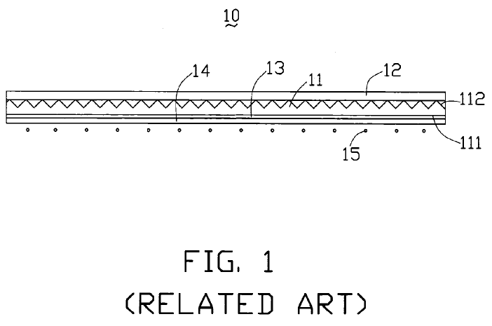

FIG. 2 is an enlarged, partially schematic view of the diffusion plate of FIG. 1;

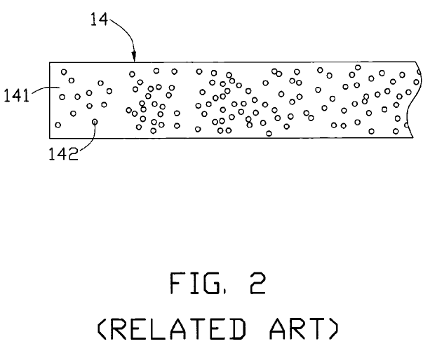

FIG. 3 is a schematic, isometric view of an optical sheet in accordance with a first embodiment;

FIG. 4 is a schematic, cross-sectional view taken along line IV-IV of FIG. 3;

FIG. 5 is an enlarged, cross-sectional, partially schematic view of a section of edges of each protrusion unit of the optical sheet being smoothed of FIG. 4;

FIG. 6 is similar to FIG. 5, but showing bottom edges of each protrusion unit of the optical sheet being smoothed of FIG. 4;

FIG. 7 is similar to FIG. 5, but showing all of the edges of each protrusion unit of the optical sheet being smoothed of FIG. 4;

FIG. 8 is a schematic, isometric view of an optical sheet in accordance with a second embodiment;

FIG. 9 is a schematic, isometric view of a backlight module in accordance with a first embodiment; and

FIG. 10 is a schematic, isometric view of a backlight module in accordance with a second embodiment.

### DETAILED DESCRIPTION OF THE EMBODIMENTS

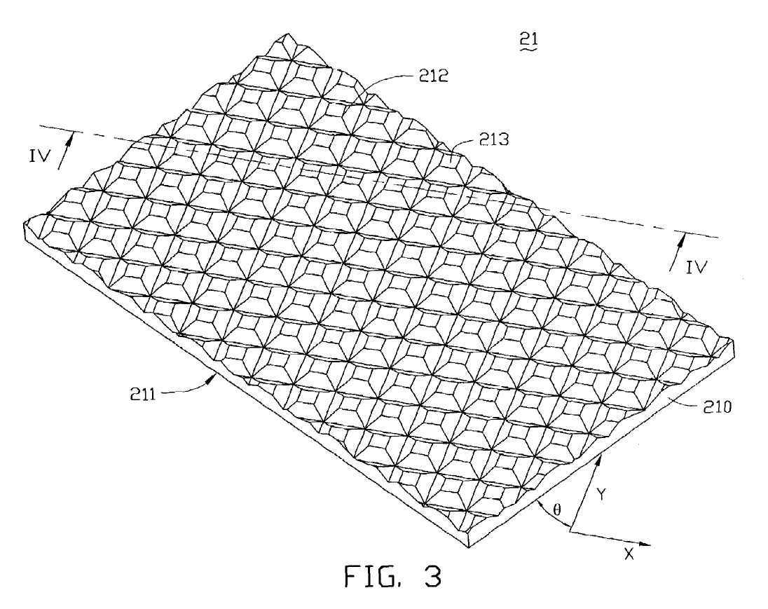

Referring to FIG. 3, an optical sheet 21 according to a first embodiment is shown. The optical sheet 21 includes a main body 210. The main body 210 includes a light incident surface 211 and a light emitting surface 212 located at opposite sides of the main body 210, and a first pair and a second pair opposite side walls (not labeled) between and adjoining the light incident surface 211 and the light emitting surface 212.

The optical sheet 21 defines a plurality of first and second elongated V-shaped grooves (not labeled) adjacent to the light emitting surface 212. The first elongated V-shaped grooves are spaced apart regularly along a first direction (the X direction shown in FIG. 3) and the second elongated V-shaped grooves are spaced apart regularly along a second direction (the Y direction shown in FIG. 3) thereby a plurality of frustum protrusions 213 are formed on the light emitting surface 212 in a matrix manner. The first V-shaped grooves intersect with the second V-shaped grooves at right angles, in other words, the first direction is perpendicular to the second direction. A depth of each second V-shaped groove is equal to that of each first V-shaped groove. The frustum protrusions 213 each include a pair of first opposite trapezium side surfaces, a pair of second opposite trapezium side surfaces, and a square top surface connecting with the four trapezium side surfaces. The first opposite trapezium side surfaces of each frustum protrusion 213 are coplanar and regularly aligned parallel to the first direction, and the second opposite trapezium side surfaces of each frustum protrusion 213 are coplanar and regularly aligned parallel to the second direction.

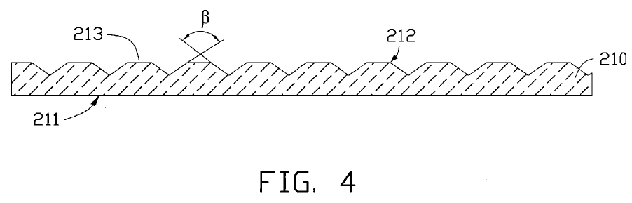

Referring also to FIG. 4, the main body 210 is substantially transparent and is made of plastic materials. The light incident surface 211 is a flat surface. The light emitting surface 212 is a combined surface including the top surfaces, the first opposite trapezium side surfaces of each frustum protrusion 213, and the second opposite trapezium side surfaces of each frustum protrusion 213. In the first embodiment, the first pair side walls of the main body 210 are perpendicular to the second pair opposite side walls of main body 210. The first direction is not perpendicular to the first pair side walls of the main body 210. The second direction is not perpendicular to the second pair side walls of the main body 210 and has an intersecting angle θ relative to the second pair side walls the main body 210. The intersecting angle θ is preferred to be 45 degrees. Two side surfaces of each frustum protrusion 213 disposed along the first direction and the other two side surfaces of each frustum protrusion 213 disposed along the second direction have the same size. The first opposite trapezium side surfaces of each frustum protrusion 213 defines an intersecting angle β that is of the same as that of the second opposite trapezium side surfaces of each frustum protrusion 213. The intersecting angle β is preferred to range from 45 degrees to 135 degrees. By adjusting the intersecting angle β of each frustum protrusions 213, the optical sheet 21 can adjust a rate of light enhancement and a light emitting angle.

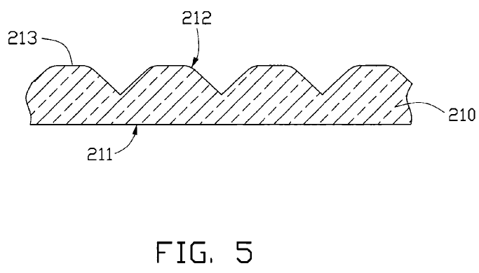

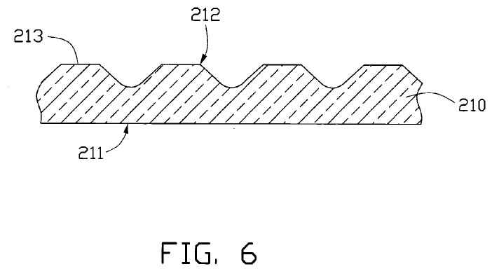

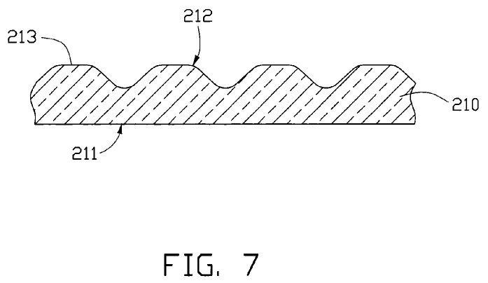

In order to limit a steep change of rate of optical illumination around edges of the protrusion units 215, a section of the edges of each protrusion unit 215 may be smoothed (shown in FIGS. 5 and 6), all of the edges of each protrusion unit 215 may also be smoothed (shown in FIG. 7).

In alternative embodiments, the first V-shaped grooves may intersect with the second V-shaped grooves at other angles, thus the first direction may intersect with the second direction at other angles. The first elongated V-shaped grooves may be spaced apart irregularly along the first direction and the second elongated V-shaped grooves may be spaced apart irregularly along the second direction. The first opposite trapezium side surfaces of each frustum protrusion 213 may be irregularly aligned parallel to the first direction, and the second opposite trapezium side surfaces of each frustum protrusion 213 may be irregularly disposed parallel to the second direction.

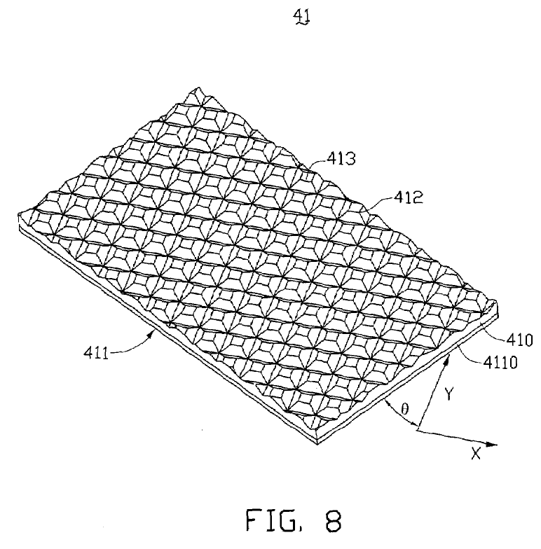

Referring to FIG. 8, an optical sheet 41 according to a second embodiment is shown. The optical sheet 41 includes a main body 410. The main body 410 includes a light incident surface 411, and a light emitting surface 412 located at opposite sides of the main body 410. The optical sheet 41 is similar in principle to the optical sheet 21 described previously, except that a dispersion layer 4110 is formed on the light incident surface 411. The dispersion layer 4110 is configured for dispersing light rays. The dispersion layer 4110 is obtained by applying a rough surface or by coating a dispersion material, for example ink.

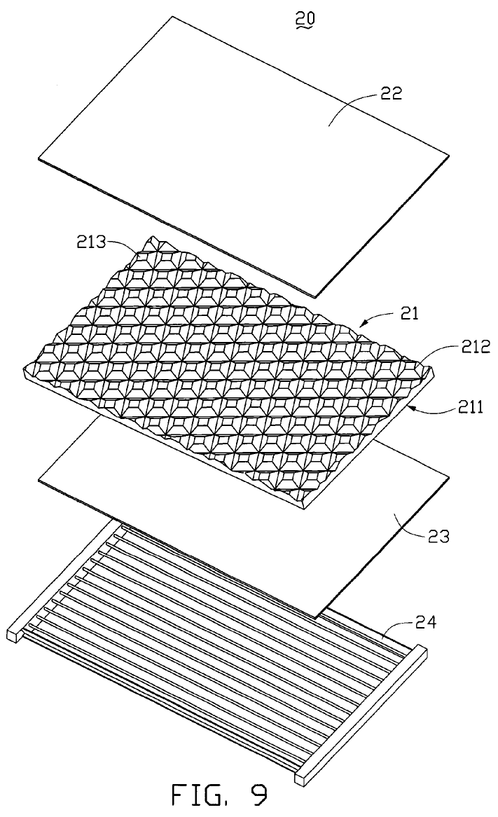

Referring to FIG. 9, a backlight module 20 according to a first embodiment is shown. The backlight module 20 includes a first diffusion sheet 22, an optical sheet 21, a second diffusion sheet 23, and a plurality of light sources 24 stacked in that order. The optical sheet 21 is described previously, and includes a main body 210. The main body 210 includes a light incident surface 211 and a light emitting surface 212 located at opposite sides of the main body 210. The optical sheet 21 defines a plurality of first and second elongated V-shaped grooves (not labeled) adjacent to the light emitting surface 212. The first elongated V-shaped grooves are spaced apart regularly along a first direction (the X direction shown in FIG. 3) and the second elongated V-shaped grooves spaced apart regularly along a second direction (the Y direction shown in FIG. 3) thereby a plurality of frustum protrusions 213 are formed on the light emitting surface 212 in a matrix manner. The optical sheet 21 is located between the first diffusion sheet 22 and the second diffusion sheet 23, with the light emitting surface 212 adjacent to the first diffusion sheet 22, and the light incident surface 211 adjacent to the second diffusion sheet 23. The light sources 24 can be selected, for example, from one of cold cathode fluorescent lamps (CCFLs) and light emitting diodes (LEDs). In the illustrated embodiment, the light sources 24 employ CCFLs.

When the backlight module 20 is in use, light rays from the light sources 24 are projected towards the second diffusion sheet 23. The light rays are emitted into the optical sheet 21 after being scattered from the second diffusion sheet 23. The light rays are refracted at the optical sheet 21 before emitted into the first diffusion sheet 22. The light rays are scattered from the first diffusion sheet 23 and finally emitted into an LCD panel (not shown).

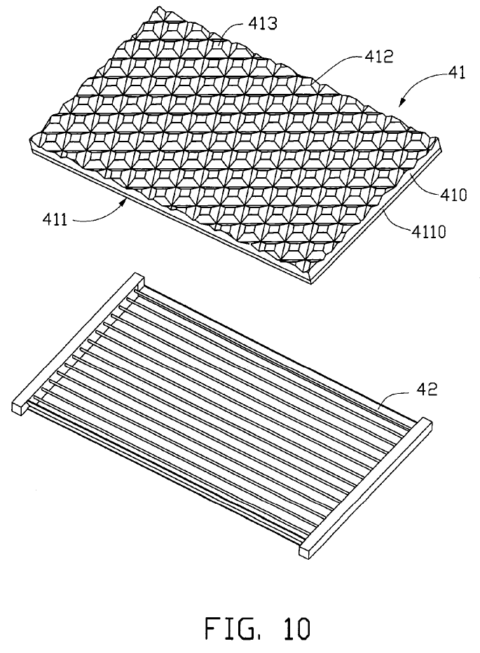

Referring to FIG. 10, a backlight module 40 according to a second embodiment is shown. The backlight module 40 includes an optical sheet 41 and a plurality of light sources 42. The optical sheet 41 is described previously, and includes a main body 410. The main body 410 includes a light incident surface 411 and a light emitting surface 412 located at opposite sides of the main body 410. A dispersion layer 4110 is formed on the light incident surface 411. The optical sheet 41 defines a plurality of first and second elongated V-shaped grooves (not labeled) adjacent to the light emitting surface 412. The first elongated V-shaped grooves are spaced apart regularly along a first direction (the X direction shown in FIG. 8) and the second elongated V-shaped grooves spaced apart regularly along a second direction (the Y direction shown in FIG. 9) thereby a plurality of frustum protrusions 413 are formed on the light emitting surface 412 in a matrix manner. The light sources 42 are located adjacent to the light incident surface 411 of the optical sheet 41. The light sources 42 can be selected, for example, from one of cold cathode fluorescent lamps (CCFLs) and light emitting diodes (LEDs). In the illustrated embodiment, the light sources 42 employ CCFLs. When the backlight module 40 is in use, light rays from the light sources 42 are projected towards the light incident surface 411 of the optical sheet 41. The light rays are scattered at the dispersion layer 4110 and refracted at the light emitting surface 412. The light rays are finally emitted into an LCD panel (not shown).

In the above-described backlight module 40, the optical sheet 41 defines a plurality of first and second elongated V-shaped grooves spaced apart regularly along a first direction and a second direction thereby the optical sheet 41 forms a plurality of frustum protrusions 213 in a matrix manner. Because the light can be refracted by the light emitting surface 412 including the top surfaces, the first opposite trapezium side surfaces of each frustum protrusion 413, and the second opposite trapezium side surfaces of each frustum protrusion 413, thus, the backlight module 40 is not likely to cause Newton ring interference action, and furthermore, improves optical uniformity. In addition, the dispersion layer 4110 locates on the light incident surface 411 of the optical sheet 41. In one hand, the light rays projected towards the optical sheet 41 are scattered by the dispersion layer 4110, and to improve optical uniformity. On the other hand, the optical sheet 41 may replace a diffusion sheet and a prism sheet. Therefore, decreasing transmission loss of the light rays in the backlight module 40, and increasing brightness of the emitted light rays of the backlight module 40.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An optical sheet, comprising:
a main body having:
a light incident surface;
a light emitting surface opposite to the light incident surface; and
a plurality of first and second elongated V-shaped grooves formed on the light emitting surface, wherein the first elongated V-shaped grooves are aligned apart and extend along a first direction, and the second elongated V-shaped grooves are aligned apart and extend along a second direction, the first direction intersecting with the second direction, whereby a plurality of frustum protrusions are formed on the emitting surface in a matrix manner.

2. The optical sheet as claimed in claim 2, wherein the frustum protrusions each includes a pair of first opposite trapezium side surfaces, a pair of second opposite trapezium side surfaces, and a square top surface connecting with the four trapezium side surfaces, the first opposite trapezium side surfaces of each frustum protrusion are coplanar and regularly aligned parallel to the first direction, and the second opposite trapezium side surfaces of each frustum protrusion are coplanar and regularly aligned parallel to the second direction.

3. The optical sheet as claimed in claim 2, wherein the main body further includes a first pair and a second pair opposite side walls between and adjoining the light incident surface and the light emitting surface, and the first direction is not perpendicular to the first pair side walls of the main body, and the second direction is not perpendicular to the second pair side walls s of the main body.

4. The optical sheet as claimed in claim 3, wherein the first opposite trapezium side surfaces and the second opposite trapezium side surfaces of each frustum protrusion have the same size, the first opposite trapezium side surfaces of each frustum protrusion defines an intersecting angle that is of the same as that of the second opposite trapezium side surfaces of each frustum protrusions.

5. The optical sheet as claimed in claim 4, wherein the intersecting angle is in the range of 45 degrees to 135 degrees.

6. The optical sheet as claimed in claim 1, wherein the first direction is perpendicular to the second direction.

7. The optical sheet as claimed in claim 1, wherein a depth of each second V-shaped groove is equal to that of each first V-shaped groove.

8. The optical sheet as claimed in claim 1, wherein at least a section of edges of each protrusion unit is smoothed.

9. The optical sheet as claimed in claim 1, further comprising a dispersion layer formed on the light incident surface, the dispersion layer being configured for dispersing light rays.

10. The optical sheet as claimed in claim 1, wherein the main body is transparent, and is made of plastic material.

11. A backlight module, comprising:
a light source; and
an optical sheet, the optical sheet including:
a main body having:
a light incident surface, the light source being positioned adjacent to the light incident surface;
a light emitting surface positioned opposite to the light incident surface; and
a plurality of first and second elongated V-shaped grooves formed on the light emitting surface, wherein the first elongated V-shaped grooves are aligned apart and extend along a first direction, and the second elongated V-shaped grooves are aligned apart and extend along a second direction, the first direction intersecting with the second direction, whereby the optical sheet forms a plurality of frustum protrusions in a matrix manner.

12. The backlight module as claimed in claim 11, wherein the first elongated V-shaped grooves are spaced apart regularly along the first direction and the second elongated V-shaped grooves are spaced apart regularly along the second direction, each of the frustum protrusions includes a pair of first opposite trapezium side surfaces, a pair of second opposite trapezium side surfaces, and a square top surface connecting with the four trapezium side surfaces, the first opposite trapezium side surfaces of each frustum protrusion are coplanar and regularly aligned parallel to the first direction, and the second opposite trapezium side surfaces of each frustum protrusion are coplanar and regularly aligned parallel to the second direction.

13. The backlight module as claimed in claim 12, wherein the first opposite trapezium side surfaces and the second opposite trapezium side surfaces of each frustum protrusion have the same size, the first opposite trapezium side surfaces of each frustum protrusion defines an intersecting angle that is of the same as that of the second opposite trapezium side surfaces of each frustum protrusions.

14. The optical sheet as claimed in claim 13, wherein the intersecting angle is in the range of 45 degrees to 135 degrees.

15. The optical sheet as claimed in claim 11, wherein the first V-shaped grooves intersect with the second V-shaped grooves at right angle.

16. The optical sheet as claimed in claim 11, wherein a depth of each second V-shaped groove is equal to that of each first V-shaped groove.

17. The optical sheet as claimed in claim 11, wherein at least a section of edges of each protrusion unit is smoothed.

18. A light guide plate comprising:
a light incident surface;
a light emitting surface positioned opposite to the light incident surface, the light emitting surface being oriented substantially parallel to the light incident surface; and
an array of protrusions arranged on a whole area of the light emitting surface, each protrusion extending perpendicularly and outwardly from the light emitting surface, and having a cross section decreasing with increasing height from the light emitting surface toward a top of the each protrusion, wherein each protrusion has a flat top surface.

19. The light guide plate as claimed in claim 19, wherein the light guide plate defines a plurality of first and second elongated V-shaped grooves on the light emitting surface, the first elongated V-shaped grooves are aligned apart and extend along a first direction, and the second elongated V-shaped grooves are aligned apart and extend along a second direction, the first direction intersecting with the second direction, thereby the protrusions are formed on the emitting surface in a matrix manner.

20. The optical sheet as claimed in claim 19, wherein the first V-shaped grooves intersect with the second V-shaped grooves at right angles.
